(19) United States
(12) Patent Application Publication
(10) Pub. No.: US 2008/0255861 A1
(43) Pub. Date: Oct. 16, 2008

(54) Online interactive career profiles

(76) Inventor: Charles Jesus Obafunwa, Baton Rouge, LA (US)

Correspondence Address: Charles Jesus Obafunwa, 5510 R. Allegheny Ct., Baton Rouge, LA, 70817, US

(21) Appl. No.: 11/641,091

(22) Filed: Apr. 16, 2007

(51) Int. Cl. G06Q 30/00

(52) U.S. Cl. 705/1

(57) ABSTRACT

Wagehunter AKA Foundation J. Enterprises, brings to the market of internet job search and staffing companies a higher level of control to job applicants. Before applicants were subject to the mercy of interpretation of their talents by recruiters and employers. Now, with the interactive resume, users can take more control over highlighting what they want viewers to notice about their resume and present it via an interactive image of themselves or a wagehunter recruiter that make the delivery more personable. It will also help with recruiter's interpretation job descriptions.

### CROSS REFERENCES TO RELATED APPLICATIONS

Cross-referencing application Ser. No. 11/641,091

### BACKGROUND OF THE INVENTION

The wagehunter application is a new introduction to the internet job search market. The wagehunter application will have features currently not offered by its competitors such as Monster.com, hotjobs.com and careerbuilder.com. The wagehunter application will use interactive avatars to serve as the voice and navigator through our subscribers online resumes.

### BREIF SUMMARY OF THE INVENTION

Not applicable.

### BREIF DESCRIPTION OF SEVERAL VIEWS OF THE DRAWING

Not applicable.

### DETAILED SUMMARY OF THE INVENTION

Our team will create interactive drawn, vector, or digitized character avatar driven resumes and interactive audio video profiles for job-seekers either from a single photo or using multiple photos. Our clients will be able to take advantage of creating a personal interactive resume for viewing anywhere and anytime. These avatars will also have the ability to allow the user to conduct an online interview with our product called (LAAVI) Live Avatar Audio Voicestream Interview. Simply, through our avatar interface on our website, the user can connect a microphone to his/her computer and as the user speaks, the employer sees the avatar speaking for the user instantly. This will benefit employers by cutting costs of travel to bring in applicants. It will also simulate a real-time interview without the need for a pc video camera. Subscribers will create accounts and build resumes with their job histories. In addition to the text history, the applicant will submit images of themselves to use for the drawing or digitizing of their image to create a virtual character used to guide employers through there resume. Here is an example of the benefit. Let's say on my resume I have listed “A+ Certified” ok, well what is that? Right now resumes would have to have a long text description in order to describe that which creates a lengthy resume. Wagehunter will have Its' users be able to create a hyperlink attached to the avatar that reads “A+ certified”, the user uploads sound files for the description of that job and the avatar will automatically sync the audio with lip movements in order to show the avatar as explaining away what it means to have that particular certification “In 2003, John Doe received his world wide accredited A+ certification which is now held by over 600,000 professionals in the I.T. market. Comptia A+ certification is now becoming the leading industry standard in the I.T. field today.” It sells the candidate, helps recruiters that are not savvy to what certain certifications and qualifications mean, and gives a more in-depth impression as opposed: to just the plain text “A+ certified” since there is not much more room to say anything else. In addition, Wagehunter will allow users to make a photo or video journal of current projects and achievements. Employers will be able to visit the professional's ‘current projects’ section of their profile and see images and text explanations of the user's day to day job activities.

1. The wagehunter interactive resume product will allow users to have a more attention grabbing resume and hold the interest of the viewer for longer.

2. Employers or recruiters will more readily brows through an interactive resume rather than a plain text resume giving the applicant the advantage of the employer's interest.

3. Professionals will be able to add virtual character of themselves or a wagehunter recruiter to serve as a resume guide to recruiters and employers. The avatar will be made from the subscriber's image or can be a stock avatar which is drawn, or digitized by vector modeling technology.

4. Subscribers will be able to keep an image or video archive of each project that they work on throughout their career. The user can store to the wagehunter site or use a portal such as photobucket.com, rockyou.com or load video through youtube.com. The benefit of this is that employers have a more in-depth view of professional's daily activities instead of relying on only a text resume.

5. Professionals will benefit from the interactive resume and current projects archive by having an active resume available for employers even while they are employed. Being able to have recruiters view your daily performance increases the professional's chances of being made an offer to be recruited and secure a higher salary.
